(19) United States
(12) Patent Application Publication
(10) Pub. No.: US 2026/0286478 A1
(43) Pub. Date: Sep. 24, 2026

(54) GRAIN-ORIENTED ELECTRICAL STEEL SHEET

(71) Applicant: NIPPON STEEL CORPORATION, Tokyo (JP)

(72) Inventors: Masataka IWAKI, Tokyo (JP); Tomohito TANAKA, Tokyo (JP); Takashi KATAOKA, Tokyo (JP)

(73) Assignee: NIPPON STEEL CORPORATION, Tokyo (JP)

(21) Appl. No.: 19/476,526

(22) PCT Filed: Apr. 26, 2024
(86) PCT No.: PCT/JP2024/016517

§ 371 Date: Oct. 17, 2025

(30) Foreign Application Priority Data
Apr. 27, 2023 (JP) 2023-073596

(51) Int. Cl. C22C 38/02

(52) U.S. Cl. CPC C22C 38/02; C22C 2202/02

(57) ABSTRACT

The grain-oriented electrical steel sheet includes a plurality of linear strains introduced in a surface and extending in a direction of 60 to 120° with respect to a longitudinal direction, in which the linear strains adjacent to each other have an interval of 2 to 10 mm in the longitudinal direction; the linear strain has a width in a direction perpendicular to an extending direction of the linear strain, and the width periodically increases and decreases in the extending direction of the linear strain in a period of 200 to 400 μm; among the linear strains, between the adjacent linear strains, the period in which the width changes is shifted by 0.4 to 0.6 periods in the extending direction of the linear strain; the ratio of the maximum of the width with respect to the minimum of the width is 1.2 to 8.0; and the minimum of the width is 30 μm or more.

### TECHNICAL FIELD

The present invention relates to a grain-oriented electrical steel sheet.

Priority is claimed on Japanese Patent Application No. 2023-073596, filed Apr. 27, 2023, the content of which is incorporated herein by reference.

### BACKGROUND ART

A grain-oriented electrical steel sheet is a soft magnetic material, and is mainly used as a core material of a transformer. Thus, the grain-oriented electrical steel sheet is required to have magnetic characteristics such as high magnetization characteristics and a low iron loss.

The iron loss is a power loss due to consumption as thermal energy that occurs when the iron core is excited by an AC magnetic field, and the iron loss is required to be as low as possible from the viewpoint of energy saving. The level of iron loss is affected by the magnetic susceptibility, the sheet thickness, the coating tension, the impurity amount, the electric resistivity, the crystal grain size, the magnetic domain size, and the like. Even at present when various techniques have been developed regarding the grain-oriented electrical steel sheet, research and development for reducing the iron loss is being continued in order to increase energy efficiency.

A technique for performing laser irradiation on a steel sheet surface has been proposed as a method for reducing the iron loss. In this technique, strain is introduced to the surface by the laser irradiation, and the 180° magnetic domain width is refined. As a result, the eddy-current loss that is a part of the iron loss can be reduced.

For example, Patent Document 1 discloses a method for manufacturing a grain-oriented electrical steel sheet in which a magnetic domain is controlled by irradiation with a laser beam. The method includes a step of repeatedly irradiating a surface of a grain-oriented electrical steel sheet with a condensed continuous-wave laser beam by scanning the grain-oriented electrical steel sheet from a rolling direction toward an inclination direction thereof while scanning portions of the continuous-wave laser beam are being shifted at intervals. When the average power of the continuous wave laser beam is represented as P (W), the scanning speed is represented as Vc (mm/s), the predetermined interval is represented as PL (mm), and an input energy Ua is defined as Ua=P/(Vc×PL)(mJ/mm²), 1.0 mm≤PL≤3.0 mm, and 0.8 mJ/mm²≤Ua≤2.0 mJ/mm² are satisfied.

Patent Document 1 discloses that iron losses in both directions of an L direction and a C direction of the grain-oriented electrical steel sheet can be reduced easily while ensuring high productivity.

In the technique of Patent Document 1, the eddy-current loss is reduced to some extent, and thereby an effect of reducing iron loss can be obtained. However, the obtained effect of reducing iron loss is not as much as expected from magnetic domain width refinement. Therefore, there is room for improvement.

Although laser irradiation to a grain-oriented electrical steel sheet as proposed in Patent Document 1 is effective for reducing iron loss, there is a problem that the closure domain formed by the laser irradiation increases magnetostriction to deteriorate noise characteristics.

Patent Document 2 discloses a manufacturing method of a grain-oriented electrical steel sheet having excellent magnetic characteristics in which the effect of reducing iron loss does not disappear even after stress relieving annealing. Patent Document 2 relates to a method for locally forming a groove in a final cold-rolled sheet, and discloses that a further lower iron loss can be obtained than in the prior art by devising the shape of the groove.

However, in the technique of Patent Document 2, the effect of reducing eddy-current loss is insufficient as compared with the technique of imparting minute thermal strain to the steel sheet by laser beam irradiation and plasma irradiation, and noise characteristics are not considered.

Patent Document 3 discloses a grain-oriented electrical steel sheet in which a plurality of strain regions extending in a direction crossing the rolling direction is locally introduced in the surface layer area of the steel sheet and formed at a periodic interval s (mm) in the rolling direction, where in each of the strain regions, closure domain regions having a periodically changing width in the rolling direction in the steel sheet surface are continuously formed over 200 mm or more in the width direction; each of the closure domain regions satisfies the conditions that the ratio of the maximum width Wmax in the rolling direction in the steel sheet surface with respect to the minimum width Wmin (Wmax/Wmin) is 1.2 or more and 2.2 or less, the average width Wave in the rolling direction in the steel sheet surface is 80 μm or more and 250 μm or less, the maximum depth D in the sheet thickness direction is 32 μm or more, and (Wave× D)/s is 0.0007 mm or more and 0.0016 mm or less.

### CITATION LIST

### Patent Documents

Patent Document 1: Japanese Patent No. 4669565
Patent Document 2: Japanese Unexamined Patent Application, First Publication No. H06-299244
Patent Document 3: Japanese Patent No. 6060988

### SUMMARY OF INVENTION

### Technical Problem

Patent Document 3 describes that the closure domain region has a periodically changing width in the rolling direction so that the magnetostrictive harmonic level can be lowered and both low iron loss and low noise can be achieved.

However, as a result of examination by the present inventors, in the technique of Patent Document 3, the width of the region where no strain is introduced changes to hinder the movement of magnetic domain walls and increase hysteresis loss, and therefore the effect of reducing iron loss due to magnetic domain width refinement cannot be sufficiently obtained.

In addition, it is considered that the obtained effect of reducing iron loss is not as much as expected from magnetic domain width refinement in Patent Document 1 because the movement of magnetic domain walls is hindered and hysteresis loss is increased.

In view of the above problems, an object of the present invention is to provide a grain-oriented electrical steel sheet having a lower iron loss than before.

### Solution to Problem

On the technique for realizing low iron loss and low noise by lowering the magnetostrictive harmonic level, the present inventors paid attention to the fact that the eddy-current loss is reduced but the hysteresis loss is increased, and studied a method for suppressing the increase in hysteresis loss to realize lower iron loss.

As a result, it has been found that, when a linear strain is introduced to the surface of a grain-oriented electrical steel sheet by laser irradiation or the like to perform magnetic domain refinement, the width of the introduced strain is periodically increased and decreased, and the period of the increase and decrease of the strain width is shifted between the adjacent linear strains, so that hysteresis loss increase can be suppressed.

The present invention has been made in view of the above findings. The gist of the present invention is as follows.
[1] In an embodiment of the present invention, a grain-oriented electrical steel sheet includes a plurality of linear strains introduced in a surface and extending in a direction of 60 to 120° with respect to a longitudinal direction, in which the linear strains adjacent to each other have an interval of 2 to 10 mm in the longitudinal direction; each of the linear strain has a width in a direction perpendicular to an extending direction of the linear strain, and the width periodically increases and decreases in the extending direction of the linear strain in a period of 200 to 400 μm; among the linear strains, between the adjacent linear strains, the period in which the width changes is shifted by 0.4 to 0.6 periods in the extending direction of the linear strain; the ratio of the maximum of the width with respect to the minimum of the width is 1.2 to 8.0; and the minimum of the width is 30 μm or more.

### Advantageous Effects of Invention

According to the embodiment of the present invention, the increase in hysteresis loss can be suppressed while reducing eddy-current loss, by magnetic domain refinement realized without hindering the movement of magnetic domain walls. As a result, a grain-oriented electrical steel sheet having a lower iron loss can be obtained.

### BRIEF DESCRIPTION OF DRAWINGS

FIG. 1 A schematic diagram illustrating an example of the grain-oriented electrical steel sheet according to the embodiment in which linear strains are introduced to the surface thereof.

FIG. 2 An example of a graph drawn using ImageJ in which the horizontal axis is DISTANCE and the vertical axis is GRAY VALUE.

### DESCRIPTION OF EMBODIMENTS

The grain-oriented electrical steel sheet according to an embodiment of the present invention (grain-oriented electrical steel sheet according to the embodiment) will be described.

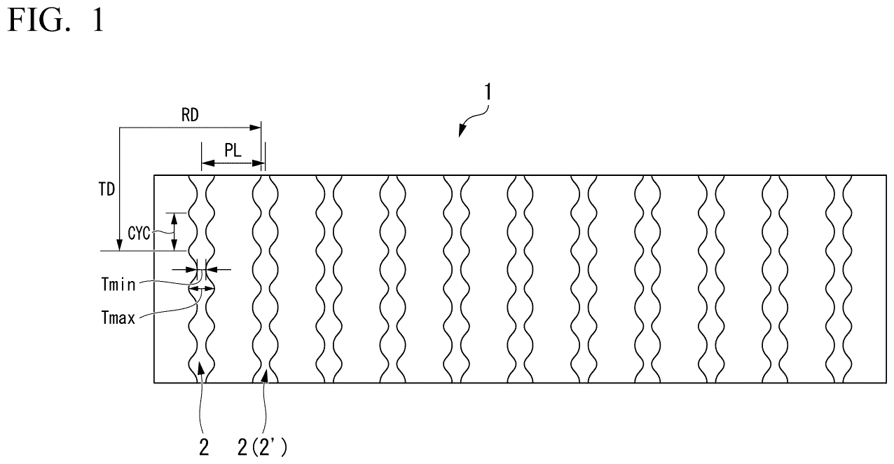

As illustrated in FIG. 1, a grain-oriented electrical steel sheet 1 according to the embodiment includes a plurality of linear strains 2 introduced in the surface and extending in a direction of 60 to 120° with respect to the longitudinal direction (longitudinal direction of the grain-oriented electrical steel sheet) RD (may be also regarded as a direction of ±30° with respect to the width direction TD), in which the linear strains 2 adjacent to each other have an interval PL of 2 to 10 mm in the longitudinal direction RD; the linear strain 2 has a width in the direction perpendicular to the extending direction of the linear strain 2, and the width periodically increases and decreases in the extending direction of the linear strain 2 in a period CYC of 200 to 400 μm; among the linear strains 2, between the adjacent linear strains 2 and 2′, the period in which the width changes is shifted by 0.4 to 0.6 periods in the extending direction of the linear strain; the ratio of the maximum Tmax of the width with respect to the minimum Tmin of the width (Tmax/Tmin) is 1.2 to 8.0; and the minimum Tmin of the width is 30 μm or more.

Each reason for limitation will be described below.

<A Plurality of Linear Strains Introduced in Surface and Extending in Direction of 60 to 120° with Respect to Longitudinal Direction (Rolling Direction)>

### <Linear Strains Adjacent to Each Other Have Interval of 2 to 10 mm in Longitudinal Direction>

In the grain-oriented electrical steel sheet, the magnetization easy axes are aligned in the longitudinal direction (rolling direction in the manufacturing process) RD. When an energy ray such as a laser or an electron beam is scanned and irradiated in a direction close to the direction perpendicular to the longitudinal direction to introduce a strain in the surface of the grain-oriented electrical steel sheet, iron loss is further reduced by an action of 180° magnetic domain refinement.

In the embodiment, the extending direction of the strain (when the strain is introduced by an energy ray such as a laser or an electron beam, corresponding to the scanning direction thereof) makes an angle of 60 to 120° against the longitudinal direction (rolling direction). When the angle is out of the range, the steel sheet is less likely to have an action of 180° magnetic domain refinement, thereby failing to sufficiently obtain the effect of reducing iron loss.

When the linear strains adjacent to each other have an interval of more than 10 mm in the longitudinal direction (normally, rolling direction) RD, the effect of magnetic domain refinement for 180° magnetic domain is reduced, and therefore the effect of improving iron loss becomes insufficient. Therefore, the linear strains adjacent to each other have an interval of 10 mm or less in the longitudinal direction. The linear strains preferably have a substantially equal interval with each other.

On the other hand, when the irradiation interval becomes small, iron loss is basically reduced. However, when the irradiation interval becomes excessively small, the effect of magnetic domain refinement is saturated, and eddy-current loss hardly decreases. On the other hand, the strain remarkably increases hysteresis loss, thereby deteriorating iron loss. In addition, noise characteristics may deteriorate. Therefore, the linear strains adjacent to each other have an interval of 2 mm or more in the longitudinal direction.

The linear strain is a continuous strain extending in one direction. In the embodiment, the width is intentionally increased and decreased as described later.

Here, in the embodiment, the interval PL of the linear strains in the longitudinal direction means the interval between the center of a linear strain and the center of an adjacent linear strain.

### <Linear Strain Has Width in Direction Perpendicular to Extending Direction of Linear Strain, and Width Periodically Increases and Decreases in Extending Direction of Linear Strain>

As described above, when an energy ray is irradiated on the surface of the grain-oriented electrical steel sheet to introduce linear strains, eddy-current loss can be reduced. On the other hand, the introduced strain inhibits the movement of magnetic domain walls. The iron loss includes eddy-current loss and hysteresis loss. When a strain is introduced, the hysteresis loss in the iron loss increases.

In order not to increase the hysteresis loss, it is preferable to reduce the amount of strain. However, on the other hand, when the amount of strain is small, the effect of magnetic domain refinement is reduced.

The present inventors have found that, when one linear strain has a periodically increasing and decreasing strain width (width in the direction perpendicular to the extending direction), the effect of magnetic domain refinement can be obtained by a small amount of strain.

However, the period of the change and the magnitude of the change need to be in the range described later in order to obtain a sufficient effect.

Here, in the embodiment, the term “periodically” means that the period is allowed to have an error of approximately ±5% or less (for example, 200 μm allows ±10 μm, and 400 μm allows ±20 μm).

<Width of Linear Strain Changes in Period of 200 to 400 μm>
<Linear Strain Has Ratio of Maximum Width with respect to Minimum Width of 1.2 to 8.0>

The grain-oriented electrical steel sheet according to the embodiment partly changes the width of the linear strain, and partly increases the same, to control the generation position of a closure domain (control the same such that a closure domain is generated from the largest position), and to control the same such that the period of width change and the magnetic domain width coincide with each other.

When the ratio of the maximum of the width with respect to the minimum of the width (width ratio) of the linear strain is less than 1.2, there is a concern that the generation position of a closure domain is unintentionally positioned, and the effect of magnetic domain refinement cannot be sufficiently obtained, as in the prior arts (strain having a uniform width is introduced).

On the other hand, even when the width ratio exceeds 8.0, there is a concern that the generation position of a closure domain is unintentionally positioned, and the effect of magnetic domain refinement cannot be sufficiently obtained. Therefore, the width ratio is 1.2 to 8.0.

Regarding the maximum value of the width, preferably, when an isosceles triangle is drawn such that the length of one period (when a profile of the width is illustrated, the length from a valley to an adjacent valley) is defined as the base, and the position of the maximum width of the linear strain is defined as the vertex, the triangle preferably has a base angle of 45° or less.

In order to sufficiently obtain the effect of magnetic domain refinement, the width of the linear strain is 30 μm or more even at the smallest position (the thinnest position).

The period of width change corresponds to the finally obtained magnetic domain width. When the period of the change is more than 400 μm, the magnetic domain width is wide, and the effect of improving iron loss cannot be sufficiently obtained.

When the period is shortened, the magnetic domain width is reduced. However, when the period is excessively shortened, the magnetic domain width becomes corresponded to a plurality of periods (For example, even when the period is 150 μm, the magnetic domain width is 300 μm, which is twice the period.). Therefore, there is rather a concern that the magnetic domain width becomes wide. Therefore, the period of width change is 200 μm or more.

<Among Linear Strains, Between Adjacent Linear Strains, Period in which Width Changes is Shifted by 0.4 to 0.6 Periods in Direction Perpendicular to Extending Direction of Linear Strain>

As described above, the width of the introduced strain is periodically changed to obtain the same magnetic domain width as one period of strain. However, when a plurality of linear strains is introduced and the linear strains are uniformly introduced, magnetic domain walls are difficult to move, and the effect of reducing iron loss due to magnetic domain width refinement cannot be sufficiently obtained.

This is presumably because the width of the linear strain periodically changes, and therefore the width of the region where no strain is introduced differs depending on place when the grain-oriented electrical steel sheet is seen in the longitudinal direction so that magnetic domain walls are difficult to move.

Therefore, in the grain-oriented electrical steel sheet according to the embodiment, among the linear strains, between the adjacent linear strains, the period in which the width changes is shifted so that the region where no strain is introduced has a substantially constant width. As illustrated in FIG. 1, the period shift is about a half period (0.5 periods), and 0.4 to 0.6 periods are acceptable. As for the shift amount, the shift amount in the extending direction is evaluated in terms of a unit of period, based on the direction perpendicular to the extending direction of the linear strain.

The portion of the grain-oriented electrical steel sheet to which the introduced linear strain is applied can be specified by the following method.

That is, in the portion of the steel sheet to which strain is applied, distortion occurs in the crystal lattice of iron due to the strain. As a method for detecting the distortion, a method called X-ray topography is used. The outline will be described below. When X-ray is incident on a normal crystal lattice, the X-ray is reflected at a specific incident angle and reflection angle corresponding to each crystal lattice plane. In this case, the incident angle and the reflection angle are equal to each other. This is called the Bragg diffraction condition. However, due to crystal distortion, that is, due to the magnitude of crystal distortion of iron in the present patent, the reflection angle slightly changes from the incident angle or the reflection intensity is weakened. This is an analysis method utilizing the phenomenon.

In the analysis, the X-ray topography device to be used is XRTmicron manufactured by Rigaku, and the X-ray source is a Cu target. The diffraction plane for photographing is (310) of iron. The CCD resolution is 2.4 μm, and the Digital resolution is 16 bits.

As the procedure, first, the grain-oriented electrical steel sheet applied with a strain by an energy ray is processed into 100 mm in the rolling direction and 100 mm in the sheet width direction by cutting or the like to prepare a sample. When a processing strain is applied to the steel sheet during the processing, the processing strain affects the X-ray reflection behavior, and therefore the processing needs to be carefully performed. For the obtained sample, although a usual grain-oriented electrical steel sheet has an insulating coating provided on the surface thereof, the strain-applied portion can be specified regardless of whether an insulating coating is provided or not. Therefore, it is important to prepare the sample such that less processing strain is applied in accordance with the state of the original sample. Then, with respect to the sheet width direction, a topography image is captured by Snap Shot in the high-resolution mode. For capturing the same, the visual field diameter is 6 to 7 mm in the sheet width direction and 7 to 8 mm in the rolling direction. A time delay integration (TDI) scan may be performed in advance in order to determine the capturing portion.

Next, from the captured topography image, the portion to which strain is applied is specifically specified using image analysis software called ImageJ.

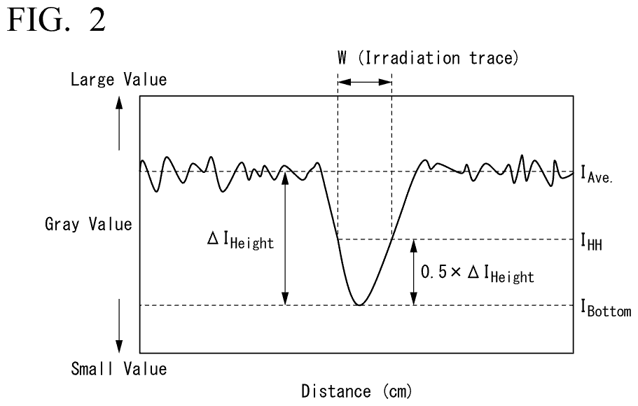

For specifying the same, the topography image is developed on ImageJ, and the range of interest (ROI) is set as an analysis range (the width and height of each pixel are 2.406 μm). ROI has a rectangular shape, and the range thereof includes 646 pixels (corresponding to about 1.55 mm) in the rolling direction and 84 pixels (corresponding to about 0.20 mm) in the sheet width direction. Hereinafter, the side parallel to the rolling direction is referred to as ROI long side, and the side parallel to the sheet width direction is referred to as ROI short side. ROI is set such that the portion to which strain is applied is included within the rectangular shape. Herein, ROI is set such that the portion to which strain is applied is positioned at the center of the ROI long side, which may be visually checked. After the ROI setting is completed, a graph is then drawn in the ROI setting range, where the horizontal axis is defined as DISTANCE, and the vertical axis is defined as GRAY VALUE. The function of ImageJ includes a graph drawing function, which is used therefor. Thus, a spectrum having a negative peak is obtained as shown in FIG. 2. The Gray Scale is read for the plateau-shaped portion at both ends of the spectrum, and the average value thereof is calculated. Hereinafter, the average value is called I_{Ave}. In the spectrum, the negative peak intensity (minimum value of the spectrum) is defined as I_{Bottom}. The difference between I_{Ave}. and I_{Bottom} is defined as ΔI_{Height}. Here, a concept called I_{HH} (Half Height), which can be defined by the following equation, is introduced. I_{HH} is the Gray Scale value corresponding to half of the peak intensity. The width W of the portion to which strain is applied is defined as the DISTANCE between the two points corresponding to I_{HH}.

$${I}_{HH} = {I}_{Height} + ( 0.5 \times {I}_{Height} ) \qquad ( 1 )$$

### <Manufacturing Method>

The grain-oriented electrical steel sheet according to the embodiment exhibits its advantageous effects as long as it has the above characteristics, regardless of the manufacturing method thereof. However, the manufacturing method including the following configuration is preferable because the grain-oriented electrical steel sheet can be relatively stably manufactured:
(1) an irradiation step of scanning and irradiating the surface of a grain-oriented electrical steel sheet obtained by a known method with an energy ray, in a direction of 60 to 120° with respect to the longitudinal direction, at a substantially constant interval of 2 to 10 mm in the longitudinal direction, while periodically changing the width (thickness) of the energy ray in the direction perpendicular to the scanning direction, to introduce a plurality of linear strains in the grain-oriented electrical steel sheet.

The grain-oriented electrical steel sheet to be irradiated with an energy ray may be a steel sheet obtained by a known method, and is, for example, a grain-oriented electrical steel sheet satisfying JIS C2553: 2019. The grain-oriented electrical steel sheet preferably has a magnetic flux density B8 (magnetic flux density at 800 A/m) of 1.90 T or more, and more preferably has B8 of 1.92 T or more.

Regarding irradiation with an energy ray, in order to introduce a plurality of linear strains extending in a direction of 60 to 120° with respect to the longitudinal direction, the linear strains adjacent to each other having an interval of 2 to 10 mm in the longitudinal direction (rolling direction), an energy ray is scanned and irradiated in a direction of 60 to 120° with respect to the longitudinal direction at a substantially constant interval of 2 to 10 mm in the longitudinal direction.

The energy ray is preferably a continuous wave laser in order to obtain a continuous linear strain in the extending direction. Further, since an electron beam and a pulse wave easily generate a strain in the sheet width direction, a continuous wave laser having a continuous wave is preferable.

As the laser irradiation conditions, known conditions can be adopted as long as strain can be introduced in the surface of the grain-oriented electrical steel sheet.

When the continuous wave laser is scanned with a polygon mirror, a shutter having a width periodically changing in the scanning direction is installed immediately after the lens. Thereby, the width of the energy ray in the direction perpendicular to the scanning direction can be periodically changed.

In the scanning the same, when the position of the shutter is changed to shift the period in an arbitrary range between adjacent linear strains, the period of width change can be shifted.

### EXAMPLES

A grain-oriented electrical steel sheet having an Si content of 3.25% and having a sheet thickness of 0.23 mm was prepared. The grain-oriented electrical steel sheet had a magnetic flux density B8 of 1.93 T and an iron loss W17/50 of 0.90 W/kg.

The grain-oriented electrical steel sheet was scanned and irradiated with a continuous wave laser, in the direction (angle with respect to the longitudinal direction) shown in Table 1, at a constant interval (pitch) shown in Table 1 in the longitudinal direction (rolling direction). The scanning was performed with a polygon mirror, and a shutter having a width periodically changing in the scanning direction was installed immediately after the lens, thereby changing the strain width in the period shown in Table 1.

The shift of the period of strain width change between adjacent linear strains was as shown in Table 1.

The obtained grain-oriented electrical steel sheet was evaluated for magnetic characteristics in the following manner.

### [Magnetic Characteristics Evaluation]

For the grain-oriented electrical steel sheet of each test number, a sample having a width of 60 mm×a length of 300 mm and including the sheet width center position was collected. The length direction of the sample was parallel to the rolling direction. Using the sample, a single-sheet magnetic property test (SST test) was performed in accordance with JIS C 2556 (2015) to determine the magnetic flux density. Specifically, the sample was applied with a magnetic field of 800 A/m to determine the magnetic flux density B8 (T).

Using the sample, the iron loss W17/50 (W/kg) at a frequency of 50 Hz and a maximum magnetic flux density of 1.7 T was measured in accordance with JIS C 2556 (2015).

In addition, the hysteresis loop was measured at a maximum magnetic flux density of 1.7 T, and the eddy-current loss was determined from the hysteresis loss thus obtained and W17/50.

Table 2 shows the results.

TABLE 1

| | | Maximum | Minimum | | | Angle with respect to |
|---|---|---|---|---|---|---|
| | Period of | width/minimum | of strain | Shift of | Irradiation | longitudinal direction |
| | strain | width of strain | width | period | interval | of steel sheet |
| No. | μm | — | μm | Period | mm | ° |
| 1 | 300 | 1.0 | 50 | 0.5 | 5 | 90 |
| 2 | 300 | 4.0 | 50 | 0.5 | 5 | 90 |
| 3 | 300 | 4.0 | 30 | 0.5 | 5 | 90 |
| 4 | 300 | 4.0 | 50 | 0.5 | 1 | 90 |
| 5 | 300 | 4.0 | 50 | 0.5 | 2 | 90 |
| 6 | 300 | 1.0 | 50 | 0.5 | 2 | 90 |
| 7 | 300 | 4.0 | 50 | 0.5 | 10 | 90 |
| 8 | 300 | 4.0 | 50 | 0.5 | 15 | 90 |
| 9 | 300 | 4.0 | 50 | 0.0 | 5 | 90 |
| 10 | 300 | 4.0 | 50 | 0.3 | 5 | 90 |
| 11 | 300 | 4.0 | 50 | 0.4 | 5 | 90 |
| 12 | 300 | 4.0 | 50 | 0.6 | 5 | 90 |
| 13 | 300 | 1.2 | 50 | 0.5 | 5 | 90 |
| 14 | 300 | 3.0 | 50 | 0.5 | 5 | 90 |
| 15 | 300 | 6.0 | 50 | 0.5 | 5 | 90 |
| 16 | 300 | 8.0 | 50 | 0.5 | 5 | 90 |
| 17 | 300 | 10.0 | 50 | 0.5 | 5 | 90 |
| 18 | 300 | 4.0 | 50 | 0.5 | 5 | 90 |
| 19 | 150 | 4.0 | 50 | 0.5 | 5 | 90 |
| 20 | 200 | 4.0 | 50 | 0.5 | 5 | 90 |
| 21 | 400 | 4.0 | 50 | 0.5 | 5 | 90 |
| 22 | 600 | 4.0 | 50 | 0.5 | 5 | 90 |
| 23 | 300 | 4.0 | 50 | 0.5 | 5 | 45 |
| 24 | 300 | 4.0 | 50 | 0.5 | 5 | 60 |
| 25 | 300 | 4.0 | 50 | 0.5 | 5 | 100 |
| 26 | 300 | 4.0 | 50 | 0.5 | 5 | 120 |
| 27 | 300 | 4.0 | 50 | 0.5 | 5 | 150 |
| 28 | 300 | 4.0 | 50 | 0.5 | 5 | 180 |
| 29 | 300 | 4.0 | 20 | 0.5 | 5 | 90 |
| 30 | 300 | 4.0 | 60 | 0.5 | 5 | 90 |
| 31 | 300 | 4.0 | 100 | 0.5 | 5 | 90 |

TABLE 2

| | Eddy-current | Hysteresis | Iron | |
|---|---|---|---|---|
| | loss | loss | loss | |
| No. | W/kg | W/kg | W/kg | Note |
| 1 | 0.45 | 0.35 | 0.80 | Comparative Example |
| 2 | 0.42 | 0.33 | 0.75 | Invention Example |
| 3 | 0.43 | 0.33 | 0.76 | Invention Example |
| 4 | 0.38 | 0.45 | 0.83 | Comparative Example |
| 5 | 0.38 | 0.40 | 0.78 | Invention Example |
| 6 | 0.40 | 0.42 | 0.82 | Comparative Example |
| 7 | 0.45 | 0.34 | 0.79 | Invention Example |
| 8 | 0.47 | 0.34 | 0.81 | Comparative Example |
| 9 | 0.43 | 0.37 | 0.80 | Comparative Example |
| 10 | 0.43 | 0.37 | 0.80 | Comparative Example |
| 11 | 0.42 | 0.34 | 0.76 | Invention Example |
| 12 | 0.42 | 0.34 | 0.76 | Invention Example |
| 13 | 0.44 | 0.33 | 0.77 | Invention Example |
| 14 | 0.43 | 0.33 | 0.76 | Invention Example |
| 15 | 0.43 | 0.34 | 0.77 | Invention Example |
| 16 | 0.44 | 0.34 | 0.78 | Invention Example |
| 17 | 0.45 | 0.36 | 0.81 | Comparative Example |
| 18 | 0.42 | 0.33 | 0.75 | Invention Example |
| 19 | 0.44 | 0.36 | 0.80 | Comparative Example |
| 20 | 0.42 | 0.33 | 0.75 | Invention Example |
| 21 | 0.43 | 0.33 | 0.76 | Invention Example |
| 22 | 0.48 | 0.35 | 0.83 | Comparative Example |
| 23 | 0.47 | 0.38 | 0.85 | Comparative Example |
| 24 | 0.44 | 0.35 | 0.79 | Invention Example |
| 25 | 0.44 | 0.34 | 0.78 | Invention Example |
| 26 | 0.44 | 0.35 | 0.79 | Invention Example |
| 27 | 0.48 | 0.43 | 0.91 | Comparative Example |
| 28 | 0.50 | 0.45 | 0.95 | Comparative Example |
| 29 | 0.48 | 0.32 | 0.80 | Comparative Example |
| 30 | 0.42 | 0.34 | 0.76 | Invention Example |
| 31 | 0.42 | 0.35 | 0.77 | Invention Example |

As can be seen from Tables 1 and 2, Invention Examples Nos. 2, 3, 5, 7, 11 to 16, 18, 20, 21, 24 to 26, 30, and 31, in which a plurality of linear strains having a width changing in a predetermined period is introduced in a predetermined direction at a predetermined interval, had an iron loss (W17/50) being as low as 0.79 W/kg or less.

On the other hand, Comparative Examples Nos. 1, 4, 6, 8 to 10, 17, 19, 22, 23, and 27 to 29, in which at least one of the period of change in the linear strain width, the maximum width/minimum width of the strain, the minimum of the strain width, the shift of the period, the interval of the linear strains, and the extending direction was out of the scope of the present invention, had a large iron loss.

### INDUSTRIAL APPLICABILITY

According to the present invention, the increase in hysteresis loss can be suppressed while reducing eddy-current loss, by magnetic domain refinement realized without hindering the movement of magnetic domain walls. As a result, a grain-oriented electrical steel sheet having a lower iron loss can be obtained. Therefore, the industrial applicability is high.

### REFERENCE SIGNS LIST

1 Grain-oriented electrical steel sheet
2 Linear Strain
2′ Linear strain adjacent to 2
RD Longitudinal direction of steel sheet (grain-oriented electrical steel sheet)
TD Width direction of steel sheet (grain-oriented electrical steel sheet)
PL Interval between linear strains in longitudinal direction of steel sheet (grain-oriented electrical steel sheet)
CYC Period
Tmin Minimum of width
Tmax Maximum of width

1. A grain-oriented electrical steel sheet comprising a plurality of linear strains introduced in a surface and extending in a direction of 60 to 120° with respect to a longitudinal direction, wherein
the linear strains adjacent to each other have an interval of 2 to 10 mm in the longitudinal direction,
each of the linear strains has a width in a direction perpendicular to an extending direction of the linear strain, and the width periodically increases and decreases in the extending direction of the linear strain in a period of 200 to 400 μm,
among the linear strains, between the adjacent linear strains, the period in which the width changes is shifted by 0.4 to 0.6 periods in the extending direction of the linear strain,
a ratio of a maximum of the width with respect to a minimum of the width is 1.2 to 8.0, and
the minimum of the width is 30 μm or more.
